(19) United States
(12) Patent Application Publication
(10) Pub. No.: US 2006/0116906 A1
(43) Pub. Date: Jun. 1, 2006

(54) Health care cash management and accounts receivable factoring

(76) Inventors: P. David Otterbach, Dripping Springs, TX (US); Kendal L. Stewart, Austin, TX (US)

Correspondence Address: DILLON & YUDELL LLP, 8911 NORTH CAPITAL OF TEXAS HWY, SUITE 2110, AUSTIN, TX, 78759, US

(21) Appl. No.: 11/270,375

(22) Filed: Nov. 9, 2005

Related U.S. Application Data
(60) Provisional application No. 60/626,268, filed on Nov. 9, 2004.

(51) Int. Cl. G06Q 10/00

(52) U.S. Cl. 705/2

(57) ABSTRACT

A Financial Management Company (FMC) purchases qualified receivables and other claims generated by a medical practice's performance of certain diagnostic and other medical testing services utilizing medical testing equipment leased through the FMC. Advance payment for the purchased accounts receivable (A/R) is made to the medical practice by the FMC following the performance of the medical testing services generating the A/R, but at a fraction of the stated value of the A/R. Also, the FMC pays the medical practice's monthly lease payment for the medical testing equipment. The FMC then proceeds with claim processing and adjudication of the A/R with the insurance carrier, and retains the subsequent carrier payments on the purchased A/R. Collectively, the cash flow management and factoring system facilitates a turn-key environment for a medical practice to receive rapid reimbursement for its performance of medical testing services without concern for managing its cash flow or monthly equipment payment obligations.

### PRIORITY CLAIM

The application claims the benefit of priority under 35 U.S.C. §119(e) from U.S. Provisional Application No. 60/626,268, entitled, “Health Care Cash Management And Accounts Receivable Factoring,” filed on Nov. 9, 2004, which disclosure is incorporated herein by reference.

### BACKGROUND OF THE INVENTION

1. Field of the Invention

The illustrative embodiment of the present invention relates generally to financial management of medical services, and more particularly to cash flow management of medical testing services and equipment, and accounts receivable factoring on such medical testing services rendered utilizing such medical testing equipment.

2. Description of the Related Art

Medical bills are usually generated as a result of treatment, equipment or medicine received by a patient from a medical provider. The medical provider, such as a hospital or doctor's office, submits a claim to the insurer, health maintenance organization (HMO), government claims administrator (for example, the Medicare program) or other contractually obligated payor (hereinafter the “carrier”) on behalf of the patient seeking payment for the services rendered. The carrier pays for the services within the claim based on its contractual obligations to both the patient and medical provider. The payments may be pre-determined amounts for specific procedures or pre-determined percentages of the amount submitted. Alternatively, the payment amount may be determined by the carrier on a case-by-case basis.

The cost of healthcare continues to increase as the healthcare industry becomes more complex, specialized, and sophisticated. This complexity and specialization has created large administrative systems that coordinate the delivery of healthcare between healthcare providers, administrators, patients, and carriers. Although beneficial in some respects, the administrative system has increased the overall cost of healthcare, while, at the same time, making it difficult for healthcare providers to receive rapid payment for services rendered. There are several reasons to account for the detrimental effect large administrative systems have had on the quick payment of claims for healthcare services. For example, a single health management organization may receive tens of thousands of payment requests each day and tens of millions of requests a year. The sheer volume of payment requests alone creates a backlog of unpaid claims. Additionally, the contractual obligations between healthcare providers, administrators, patients, and carriers are complex and may change frequently, further slowing the payment process.

Studies have shown that some insurance claims submission systems reject up to seventy percent of claims on their first submission for including inaccurate or incorrect information or for other reasons. Many of the claims are eventually paid, but only after they have been revised in response to rejections. In other instances, insurance claims are not paid because of patient ineligibility, claims made on diagnosis and treatments that are not eligible for payment, or for other mechanical or legal reasons. As can be appreciated, this complication of the healthcare payment system in combination with the multiple cycles required to correct errors in the submission process continues to decrease the efficiency of the healthcare system and substantially increase the time it takes to process a claim.

During recent years, there has been an attempt to expedite the payment of healthcare services by automating the process for creating, receiving, and adjudicating payment requests. For example, there currently exists claim processing systems whereby healthcare providers electronically create and submit medical insurance claims to a central processing system. However, even using these automated systems, it is difficult to determine whether the claim is in condition for payment. For example, it has been found that a large number of insurance claims are submitted with information that is incomplete, incorrect, or that describes diagnoses and treatments that are not eligible for payment. As a result, the healthcare provider is typically not made aware of the deficiencies of the submitted claims by an automated system. It is not until much later, potentially weeks afterwards, when the disposition of the insurance claim is communicated to the healthcare provider. As a result, even many automated claims are subject to multiple submissions and adjudication cycles as they are created, rejected and amended. Accordingly, automated systems that are designed to improve the efficiency of the healthcare management systems have ultimately failed to provide an adequate means for promptly paying healthcare providers for services rendered.

The resulting delays in receiving payment for patient treatment in the healthcare industry have created cash flow problems for providers. This has been particularly true for healthcare providers who purchase customized equipment and hire experienced staff to provide specialized testing and diagnostics of patient conditions. Given the high expense of such complex medical diagnostic and testing equipment, medical providers often finance such capital purchases through loans or leases. With the significant time lag of sometimes up to sixty days between the time services are rendered to a patient and when payment from the carrier is received for those services, the healthcare provider is forced to carry the significant financial cost of this equipment, as well as other capital expenditures, overhead and operational costs of the specialized medical testing services during the delay. To resolve these cash flow issues, healthcare providers typically maintain sufficient cash or credit on hand to cover the cash flow demands needed to meet its financial obligations.

In view of the foregoing, there is a need in the art to provide healthcare providers with payment for services rendered in advance of carrier payments on claims for such services, particularly for services rendered on expensive medical diagnostic or test equipment. It would also be advantageous to provide for the advance payment of the monthly loan or lease payment on such equipment as those payments become due. It would be further advantageous to provide healthcare providers advance payment for services rendered that eliminates the risk the claim won't be paid because of errors in the claim form, errors in the administrative process or changes in contractual arrangements.

### SUMMARY OF THE INVENTION

In accordance with the present invention, improved methods, systems and articles of manufacture for cash flow management and accounts receivable factoring are disclosed. One preferred method of the present invention comprises a Financial Management Company (FMC) purchasing qualified receivables and other claims generated by a medical practice's performance of certain diagnostic and other medical testing services utilizing medical testing equipment leased through the FMC. Advance payment for the purchased accounts receivable (A/R) is made to the medical practice by the FMC following the performance of the medical testing services generating the A/R, but at a fraction of the stated value of the A/R. Also, the FMC pays the medical practice's monthly lease payment for the medical testing equipment. The FMC then proceeds with claim processing and adjudication of the A/R with the insurance carrier, and retains the subsequent carrier payments on the purchased A/R. Collectively, the cash flow management and factoring system facilitates a turn-key environment for a medical practice to receive rapid reimbursement for its performance of medical testing services without concern for managing its cash flow or monthly equipment payment obligations.

All objects, features, and advantages of the present invention will become apparent in the following detailed written description.

### BRIEF DESCRIPTION OF THE DRAWINGS

This invention is described in a preferred embodiment in the following description with reference to the drawings, in which like numbers represent the same or similar elements and one or a plurality of such elements, as follows:

FIG. 1 shows a block diagram of a health service and equipment financial payment system according to a preferred embodiment of the invention.

FIG. 2 shows a flow diagram of a process for providing cash management services and accounts receivable factoring to licensed healthcare practitioners and professional associations, in accordance with the preferred embodiment of the present invention.

In the accompanying drawings, elements might not be to scale and may be shown in generalized or schematic form or may be identified solely by name or another commercial designation.

### DETAILED DESCRIPTION OF PREFERRED EMBODIMENTS

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

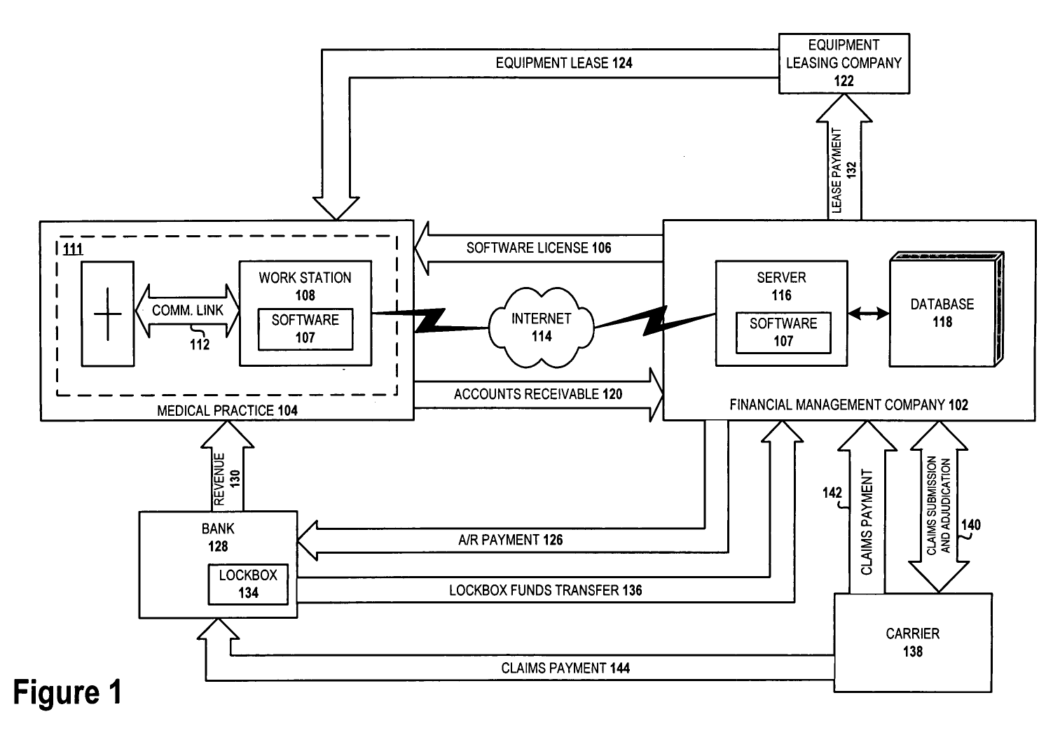

With reference now to FIG. 1, there is shown a block diagram of a health service financial system for advance payment and equipment leasing according to a preferred embodiment of the present invention. The health service financial system of the preferred embodiment includes a client system located at the offices of a healthcare provider and a remote server system that operate in conjunction to promptly pay healthcare providers for services rendered even before payment requests for rendered services can be processed and adjudicated by the corresponding carrier or payors. Further, the preferred embodiment provides financial management of the expensive medical equipment used to facilitate the compensated medical services.

Financial Management Company (FMC) 102 maintains data processing server 116 and database 118 to facilitate the cash management services and accounts receivable factoring provided to healthcare practitioners and professional associations. Software 117 is instructions, programs, routines, and symbolic languages that control the functioning of data processing server 116 and other hardware to direct their operation. In accordance with a preferred embodiment, FMC 102 enters into a business arrangement with medical practice (MP) 104 to provide cash management and accounts receivable factoring services. As part of that arrangement, FMC 102 licenses proprietary software 107 to MP 104 via a software license 106 for the operation of medical testing equipment 111. Medical testing equipment 111 includes a data processing work station 108 controlled by software 107 and medical equipment 110, all interconnected by communications link 112. Software 107 is instructions, programs, routines, and symbolic languages that control the functioning of hardware and direct its operation. The software 107 operates work station 108 to permit diagnostic testing services to be performed by medical equipment 110 on patients of MP 104. The software 107 also provides a communication function over network 114 between workstation 108 and data processing server 116 to channel processing of insurance claims (identified in FIG. 1 as “Accounts Receivable 120”) to be paid on diagnostic testing services performed by MP 104.

With reference again to FIG. 1, MP 104 also contracts with equipment leasing company 122 to lease medical testing equipment 111 via equipment lease 124. In an alternative preferred embodiment of the present invention, MP 104 purchases medical testing equipment 111, instead of leasing, and borrows the funds necessary to purchase the equipment from the equipment leasing company 122 (or a bank 128) via a loan that substitutes for equipment lease 124.

Qualified receivables and other carrier claims are generated by the performance of medical testing services on medical equipment 111 for patients of MP 104. In accordance with a preferred embodiment, immediately upon performance of the medical testing services on medical equipment 111, software 107 generates and transmits accounts receivable (A/R) 120 to FMC 102 for claims processing and accounts receivable factoring. Accounts receivable 120 are automatically transmitted from workstation 108 over internet 114 to server 116 by operation of the software 107 in communication with server software 117, immediately upon creation of the accounts receivable or periodically in a batch mode.

The cash flow management and factoring methodology is performed in part or whole by operation of server 116 under the instruction of server software 117. In a preferred embodiment, the process of cash flow management and factoring is performed by server software 117 and user control of server 116.

Upon receiving an account receivable 120, FMC 102 determines if such account is a qualified account based on predetermined criteria between MP 104 and FMC 102. If FMC 102 accepts the account receivable 120 as a qualified account, FMC 102 purchases the qualifying accounts receivable 120 of MP 104. The purchase price for qualifying accounts receivable 120 is pre-negotiated between FMC 102 and MP 104, and is payable to MP 104 within approximately seven (7) days following the submission of the accounts receivable 120 to FMC 102. FMC 102 pays MP 104 the A/R purchase price by making a funds transfer of A/R payment 126 to MP's bank 128 through a daily (or periodic) electronic funds transfer equal to the agreed upon percentage or fixed amount of the value of the accounts receivable 120. MP's bank 128 then passes the cash proceeds of the purchase as revenues 130 back to MP 104 as arranged by those parties.

Moreover, as further compensation for accounts receivable 120, FMC 102 makes a lease payment 132 on equipment lease 124 to equipment leasing company 122 on behalf of MP 104. FMC 102 periodically makes lease payment 132 equal to a specified percentage of MP 104's lease payment obligation under equipment lease 124 for each “account” purchased by FMC 102 as part of accounts receivable 120. In a preferred embodiment, FMC 102 continues to pay lease payments 132 in a given calendar month only until MP 104's monthly lease payment under equipment lease 124 has been paid in full for that month. Thereafter, FMC 102 begins to make additional lease payments 132 at the beginning of the next calendar month for accounts receivable 120 in the next month.

As an example of the purchase of A/R, medical practice 104 might receive an A/R payment 126 equal to fifty percent (50%) of the face-value of the accounts receivable 120 being billed to the patient's carrier 138. In this example, the medical practice has sold the accounts receivable at half their face-value in return for a significantly reduced delay between performing the services and receiving compensation, and an elimination of the risk of reduced payment or non-payment of the accounts receivable. The medical practice also has, in one view, been provided the medical testing equipment to produce the medical testing revenues for free, or in an alternative view, has had its lease or loan obligation on the medical testing equipment paid as part of its compensation for the sale of accounts receivable.

Once purchased, FMC 102 formalizes accounts receivable 120 into claim submissions suitable for a corresponding carrier 138 designated as the payor of an applicable account receivable. Medical practice 104 appoints FMC 102 as its agent and attorney-in-fact to process all claims submissions for insurance claims under accounts receivable 120, and then all accounts receivable to be paid directly by a carrier are billed in the name of FMC 102. For Medicare accounts, all such accounts receivable are billed in the name and provider number of the medical practice 104 and designated as payable to lockbox 134. FMC 102 processes each claim through the specified claims submission and adjudication process 140 promulgated by the applicable carrier 138 by submitting and re-submitting the billing, medical and patient information necessary for carrier 138 to grant the corresponding claim payment 144 on the corresponding account receivable 120. As will be appreciated, the claims submission and adjudication 140 is unique to each carrier 138, but is readily available and well understood by those in the health care industry.

Upon completion of the claims submission and adjudication process 140, carrier 138 makes a claims payment 142 back to FMC 102 on the corresponding accounts receivable 120, typically thirty (30) to sixty (60) days following the first claim submission to carrier 138. Depending upon the carrier's procedures and processes, payment may be required to be sent directly to the medical practice or physician and not a third party assignee of the accounts receivable. For example, Medicare payments must be sent to the physician performing the medical services. In that situation, the claims payment 142 is not paid, and instead a payment is made by carrier 138 as claims payment 144 into lockbox 134 at the medical practice's bank 128. Lockbox 134 is an independent bank account owned and held by medical practice 104. Medical practice 104 will have standing instructions with bank 128 to transfer all finds in lockbox 134 to FMC 102 via a periodic lockbox funds transfer 136.

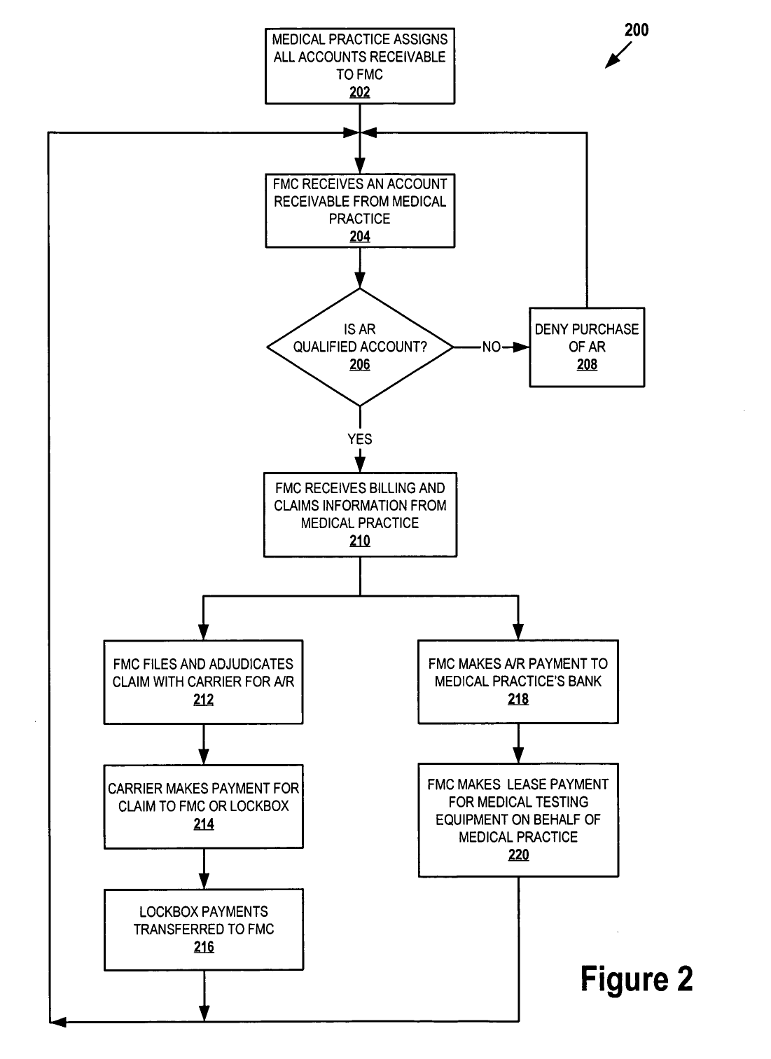

With reference now to FIG. 2, there is shown a flow diagram of a process for providing cash management services and accounts receivable factoring to licensed healthcare practitioners and professional associations, in accordance with a preferred embodiment of the present invention. Process 200 begins at step 202 upon a medical practice 104 assigning some or all its accounts receivable (A/R) 120 for certain medical testing services to FMC 102, and designating all related bills as payable to FMC 102 or the lockbox 134. Thereafter, the process proceeds to step 204 when FMC 102 receives an account receivable 120 from the medical practice. Proceeding to decision block 206, FMC 102 determines if the account receivable 120 is a qualified account. If not, the purchase by FMC of that A/R from the medical practice 104 is denied at step 208, and thereafter the process returns to step 204 to await receipt of another account receivable from the medical practice. If it is determined that the account receivable 120 is a qualified account, the process proceeds to step 210, where the medical associated billing and claims information is received by FMC 102 from medical practice 104. Thereafter, the process proceeds to both steps 212 and 218. Although steps 212-216 are described as being processed in parallel with steps 218-220, these steps may be performed in series in alternative embodiments.

At step 212, FMC files and adjudicates the claim corresponding to the received A/R with the carrier responsible for paying the patient's medical claim on the account receivable. Upon determining the accuracy of the A/R and meeting the qualifications and requirements of the claim at step 214, the carrier makes a claim payment directly to FMC or a lockbox bank account held in trust for the medical practice, depending upon whether such payment may be made to a third-party assignee or must be paid to the medical practitioner performing the medical services. As seen at step 216, payments made to the lockbox, if any, are transferred to FMC by the medical practice's bank. The process then returns to step 204 to await receipt of another account receivable from the medical practice.

At step 218, FMC makes an A/R payment to the medical practice's bank. This A/R payment is a pre-agreed percentage of the face-value of the account receivable transferred to FMC at step 204. In a preferred embodiment, the payment by FMC at step 218 is performed, on average, much sooner than the payment by the carrier at step 214. Thereafter, the process proceeds to step 220, where FMC makes a lease payment equal to a predetermined percent of the monthly lease payment for the medical testing equipment used to generate the accounts receivable on behalf of the medical practice. Thereafter, the process returns to step 204 to await receipt of another account receivable from the medical practice.

It will be appreciated by one of ordinary skill in the art that the method described above will typically be carried out in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

Accordingly, the present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analog communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system RON or fixed disk, or distributed from a server or electronic bulletin board over a network, for example, the Internet or World Wide Web.

While the invention has been particularly shown and described with reference to a preferred embodiment, it will be understood by those skilled in the art that various changes in form and detail may be made therein without departing from the spirit and scope of the invention. Any variations, modifications, additions, and improvements to the embodiments described are possible and may fall within the scope of the invention as detailed within the following claims.

What is claimed is:

1. A method comprising:
receiving an account receivable (A/R) for certain medical testing services performed by a medical practice;
paying an A/R payment to the medical practice, wherein the A/R payment is a percentage of a presumed value of the A/R;
submitting a medical claim, corresponding to medical services performed by the medical practice creating the A/R, with a carrier responsible for paying a medical claim with respect to the A/R; and
receiving a claim payment for the medical claim on the A/R as assignee of the A/R.

2. The method according to claim 1, further comprising the step of receiving an assignment of a plurality of accounts receivable for certain medical testing services performed by the medical practice, wherein the A/R is one of the plurality of accounts receivable.

3. The method according to claim 1, further comprising the step of determining if the assigned account receivable is a qualified account, and, if not, denying the purchase of that A/R from the medical practice.

4. The method according to claim 1, further comprising receiving medical-associated billing and claims information from medical practice required for submitting the medical claim.

5. The method according to claim 1, further comprising adjudicating the medical claim with the carrier following submitting the medical claim.

6. The method according to claim 1, wherein the step of receiving a claim payment comprises receiving the claim payment indirectly through a lockbox bank account held in trust for the medical practice.

7. The method according to claim 1, wherein the step of paying is performed prior to receiving the claim payment.

8. The method according to claim 1, further comprising the step of paying a lease payment for medical testing equipment on behalf of the medical practice equal to a predetermined percent of the lease payment, wherein the medical testing equipment is used in conjunction with the medical services performed by the medical practice creating the A/R.

9. A system comprising:
a processing element;
a storage element;
one or more medical devices; and
program logic embedded in the storage element for performing the steps of:
sending an account receivable (A/R) for certain medical testing services performed by a medical practice utilizing the one or more medical devices to a company that receives a claim payment for a medical claim on the A/R as assignee of the A/R, wherein the company submits the medical claim, corresponding to medical services performed by the medical practice creating the A/R, with a carrier responsible for paying a medical claim with respect to the A/R; and
receiving an A/R payment from the company, wherein the A/R payment is a percentage of a presumed value of the A/R.

10. The system according to claim 9, wherein the program logic further sends the company medical-associated billing and claims information from medical practice required for submitting the medical claim.

11. The method according to claim 1, further comprising adjudicating the medical claim with the carrier following submitting the medical claim.

12. The method according to claim 1, wherein the step of receiving an A/R payment comprises receiving the A/R payment indirectly through a bank.

13. The method according to claim 1, wherein the step of receiving the A/R payment is performed prior to the company receiving the claim payment.

14. An article of manufacture comprising machine-readable medium including program logic embedded therein that performs the steps of:
receiving an account receivable (A/R) for certain medical testing services performed by a medical practice;
paying an A/R payment to the medical practice, wherein the A/R payment is a percentage of a presumed value of the A/R;
submitting a medical claim, corresponding to medical services performed by the medical practice creating the A/R, with a carrier responsible for paying a medical claim with respect to the A/R; and
receiving a claim payment for the medical claim on the A/R as assignee of the A/R.

15. The article of manufacture according to claim 14, further comprising the step of determining if the assigned account receivable is a qualified account, and, if not, denying the purchase of that A/R from the medical practice.

16. The article of manufacture according to claim 14, further comprising receiving medical-associated billing and claims information from medical practice required for submitting the medical claim.

17. The article of manufacture according to claim 14, further comprising adjudicating the medical claim with the carrier following submitting the medical claim.

18. The article of manufacture according to claim 14, wherein the step of receiving a claim payment comprises receiving the claim payment indirectly through a lockbox bank account held in trust for the medical practice.

19. The article of manufacture according to claim 14, wherein the step of paying is performed prior to receiving the claim payment.

20. The article of manufacture according to claim 14, further comprising the step of paying a lease payment for medical testing equipment on behalf of the medical practice equal to a predetermined percent of the lease payment, wherein the medical testing equipment is used in conjunction with the medical services performed by the medical practice creating the A/R.
